(19) United States
(12) Patent Application Publication
(10) Pub. No.: US 2013/0063822 A1
(43) Pub. Date: Mar. 14, 2013

(54) LENS MODULE HAVING LIGHT-SHIELDING PLATE

(71) Applicant: TSUNG-YU LIN, Tu-Cheng (TW)

(72) Inventor: TSUNG-YU LIN, Tu-Cheng (TW)

(73) Assignee: HON HAI PRECISION INDUSTRY CO., LTD., Tu-Cheng (TW)

(21) Appl. No.: 13/448,422

(22) Filed: Apr. 17, 2012

(30) Foreign Application Priority Data
Sep. 14, 2011 (TW) 100132946

(51) Int. Cl. G02B 7/02; G02B 13/18

(52) U.S. Cl. 359/601

(57) ABSTRACT

A lens module includes a lens barrel receiving a first lens, an annular light-shielding plate, and a second lens. The first lens includes a first imaging portion and a first non-imaging portion surrounding the first imaging portion. The first non-imaging portion includes a first mounting surface and a second mounting surface opposite to the first mounting surface. The second lens includes a second imaging portion and a second non-imaging portion surrounding the second imaging portion. The second non-imaging portion includes a third mounting surface. The first mounting surface, the second mounting surface, and the third mounting surface are perpendicular to an optical axis of the lens module. The light-shielding plate is mounted between the second mounting surface and the third mounting surface and totally covers the first non-imaging portion in a projection plane perpendicular to the optical axis.

### BACKGROUND

1. Technical Field

The present disclosure relates to lens modules and, particularly, to a lens module having light-shielding plates.

2. Description of Related Art

Lens modules may include two lenses, each of which has an imaging portion for imaging and a non-imaging portion surrounding the imaging portion for assembling. The lenses are combined by engagement of the peripherals of the non-imaging portions. The lens module may also include an annular light-shielding plate sandwiched between the non-imaging plates blocking light rays from passing through the non-imaging portions, avoiding adversely affecting the image quality. However, to ensure tight engagement between the lenses, the light-shielding plate typically does not interleave into the engagement of the lenses. As such, light rays may pass through the non-imaging portions through the engagement portion, which may degrade the image quality.

Therefore, it is desirable to provide a lens module, which can overcome the limitations described.

### BRIEF DESCRIPTION OF THE DRAWINGS

FIG. 1 is a cross-sectional schematic view of a lens module of an exemplary embodiment.

FIG. 2 is a partial view of the lens module of FIG. 1.

### DETAILED DESCRIPTION

Embodiments of the disclosure will now be described in detail, with reference to the accompanying drawings.

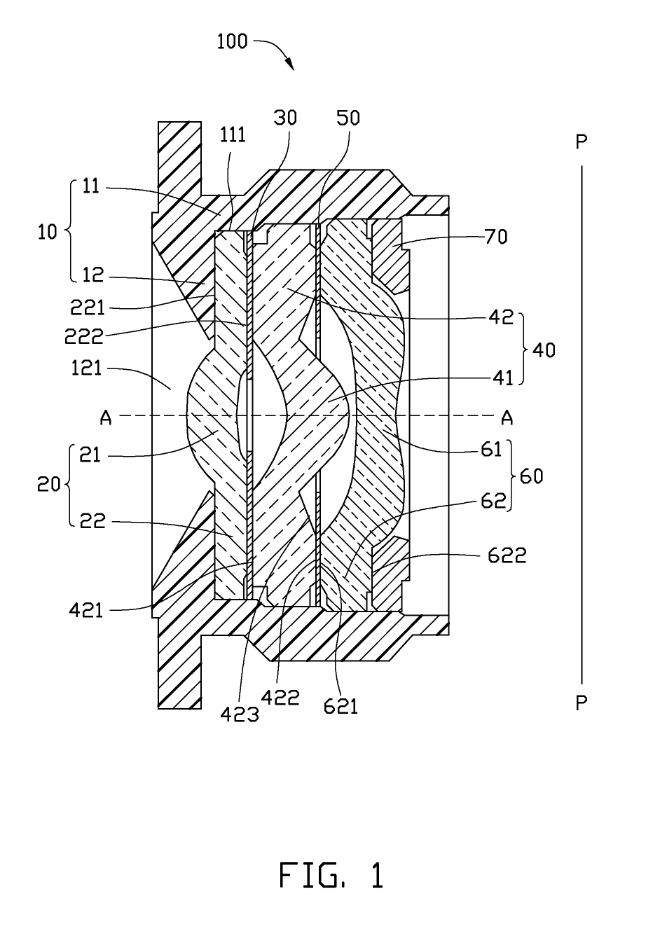

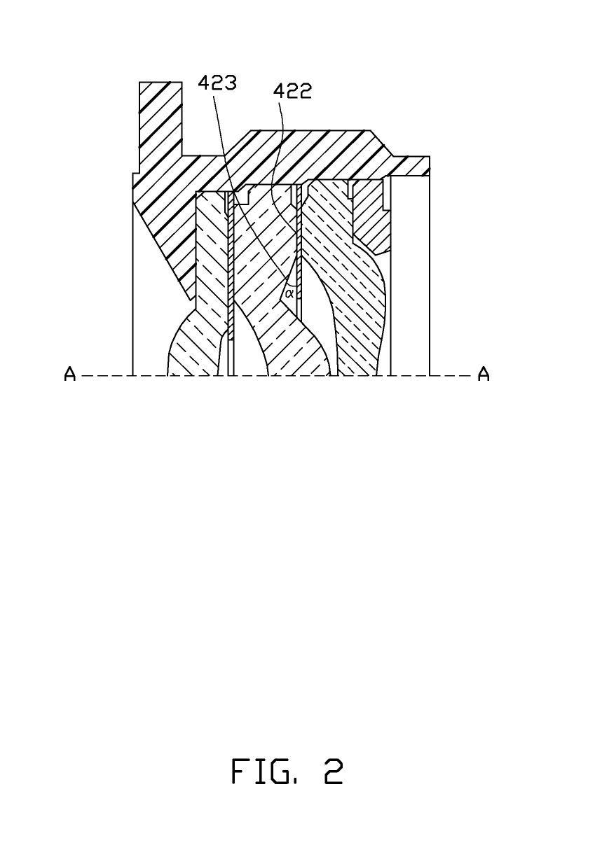

FIGS. 1 and 2, show a lens module 100, according to an exemplary embodiment, including a lens barrel 10, a first lens 20, a first light-shielding plate 30, a second lens 40, a second light-shielding plate 50, a third lens 60 and a spacer 70. The first lens 20, the first light-shielding plate 30, the second lens 40, the second light-shielding plate 50, the third lens 60, and the spacer 70 are received in the lens barrel 10 in that order from an object-side to an image-side of the lens module 100.

The lens barrel 10 is generally a hollow cylinder and includes a main body 11 and an annular aperture plate 12. The aperture plate 12 is positioned at the object-side end of the main body 11 and is integrally formed with the main body 11. The aperture plate 12 defines an aperture 121 generally at the center to allow light rays from an object (not shown) to enter the lens barrel 10. In the illustrated embodiment, the aperture 121 tapers towards the image-side of the lens barrel 10, which is beneficial for controlling incident angles of the light rays. The main body 11 includes a stepped inner sidewall 111. In this embodiment, the lens barrel 10 is made of black plastic, the inner sidewall 111 can efficiently absorb light rays projecting thereon, thus improving image quality of the lens module 100. The aperture plate 12 includes a plane interior surface perpendicular to an optical axis AA of the lens module 100.

The first lens 20 is made of plastic and is an aspherical lens of positive refractive power. The first lens 20 includes a first imaging portion 21 and a first non-imaging portion 22. The first imaging portion 21 is convex toward the aperture 121 and refracts light rays from the object. The first non-imaging portion 22 surrounds the first imaging portion 21 to support the first imaging portion 21. The first non-imaging portion 22 includes a first mounting surface 221 facing the object side and a second mounting surface 222 opposite to the first mounting surface 221. The first mounting surface 221 and the second mounting surface 222 are perpendicular to the optical axis AA. An outer diameter of the first lens 20 corresponds to an inner diameter of the main portion 11. The first lens 20 is fixed to the inner sidewall 111 with the first mounting surface 221 attached on the interior surface of the aperture plate 12.

The first light-shielding plate 30 is annular and non-reflective. That is, the first light-shielding plate 30 can absorb about 100% of the light incident rays. An outer diameter of the first light-shielding plate 30 corresponds to that of the first lens 20. The first light-shielding plate 30 is fixed in the main portion 11 and attached to the second mounting surface 222. The first light-shielding plate 30 totally covers the first non-imaging portion 22 in a projection plane PP perpendicular to the optical axis AA. The first light-shielding plate 30 blocks light incident rays passing through the first non-imaging portion 22 from projecting to the second lens 40.

The second lens 40 is made of glass and is an aspherical lens of negative refractive power. The second lens 40 includes a second imaging portion 41 and a second non-imaging portion 42 surrounding the second imaging portion 41. The second imaging portion 41 is concave toward the first lens 20. The second imaging portion 41 refracts light incident rays from the first imaging portion 21. The second non-imaging portion 42 includes a third mounting surface 421 facing the object side, a fourth mounting surface 422 opposite to the third mounting surface 421, and a connection surface 423 connecting the second imaging portion 41 and the fourth mounting surface 422. The third mounting surface 421 and the fourth mounting surface 422 are perpendicular to the optical axis AA. The connection surface 423 is generally conical and forms an acute angle a related to the fourth mounting surface 422. In this embodiment, the acute angle a is greater than 15 degrees and less than 45 degrees. The second non-imaging portion 42 is fixed to the inner sidewall 111. The third mounting surface 421 is attached to the first light-shielding plate 30, such that the first light-shielding plate 30 is disposed between the first lens 20 and the second lens 40.

The second light-shielding plate 50 is also non-reflective. That is, the first light-shielding plate 30 can absorb about 100% light incident rays. An outer diameter of the second light-shielding plate 50 corresponds to that of the second lens 40. The second light-shielding plate 50 is attached to the fourth mounting surface 422. The second light-shielding plate 50 totally covers the second non-imaging portion 42 in the projection plane PP. The second light-shielding plate 50 blocks light incident rays from passing through the second non-imaging portion 42.

The third lens 60 is made of glass and is an aspherical lens of negative refractive power. The third lens 60 includes a third imaging portion 61 and a third non-imaging portion 62 surrounding the third imaging portion 61. The third imaging portion 61 is concave toward the second lens 40. The third non-imaging portion 62 includes a fifth mounting surface 621 facing the object side and a sixth mounting surface 622 opposite to the fifth mounting surface 621. The fifth mounting surface 621 and the six mounting surface 622 are perpendicular to the optical axis AA. The third non-imaging portion 62 is fixed to the inner sidewall 111. The fifth mounting surface 621 is attached to the second light-shielding plate 50, such that the second light-shielding plate 50 is disposed between the second lens 40 and the third lens 60.

The spacer 70 is annular and can be made of the plastic or rubber. In this embodiment, the spacer 70 is made of black rubber. The spacer 70 is mounted to the inner sidewall 111 and attached to the sixth mounting surface 622. The spacer 70 retains the first lens 20, the first light-shielding 30, the second lens 40, the second light-shielding plate 50, and the third lens 60 steadily fixed in the main portion 11.

In use, light rays pass through the aperture 121 and project on the first lens 20, because the first light-shielding plate 30 totally covers the first non-imaging portion 22 in the projection plane PP, a portion light rays projecting on the first non-imaging portion 20 which may influence image quality are totally blocked by the first light-shielding plate 30 from projecting to the second lens 40. Some of light rays passing through the first imaging portion 21 project to the second non-imaging portion 42. Because the second light-shielding plate 50 totally covers the second non-imaging portion 42 in the projection plane PP, light rays passing through the third mounting surface 421 and then projecting on the fourth mounting surface 422 are totally blocked by the second light-shielding plate 50, and light rays passing through the third mounting surface 421 and then projecting on the connection surface 423 will be totally reflected to the second light-shielding plate 50 and blocked by the second light-shielding plate 50, namely light rays projecting to the second non-imaging portion 42 are all totally blocked by the second light-shielding plate 50.

In alterative embodiments, the lens module 100 may only include the lens 20, the first light-shielding plate 30, and the second lens 40.

While various embodiments have been described, it is to be understood that the disclosure is not limited thereto. On the contrary, various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A lens module comprising:
a lens barrel;
a first lens received in the lens barrel and comprising:
a first imaging portion; and
a first non-imaging portion surrounding the first imaging portion; the first non-imaging portion comprising a first mounting surface and a second mounting surface opposite to the first mounting surface;
an annular first light-shielding plate received in the lens barrel for blocking light rays from the first non-imaging portion; and
a second lens received in the lens barrel and comprising:
a second imaging portion; and
a second non-imaging portion surrounding the second imaging portion;
the second non-imaging portion comprising a third mounting surface;
wherein the second mounting surface and the third mounting surface are perpendicular to an optical axis of the lens module, the first light-shielding plate is mounted between the second mounting surface and the third mounting surface and totally covers the first non-imaging portion in a projection plane perpendicular to the optical axis.

2. The lens module of claim 1, wherein an outer diameter of the first lens corresponds an inner diameter of the lens barrel, an outer diameter of the first light-shielding plate correspond to that of the first lens.

3. The lens module of claim 1, wherein the lens module further comprises a second light-shielding plate and a third lens; the second non-imaging portion further comprises a fourth mounting surface opposite to the third mounting surface; the third lens comprises a third imaging portion and a third non-imaging portion surrounding the third imaging portion; the third non-imaging portion comprises a fifth mounting surface perpendicular to the optical axis; the second light-shielding plate is mounted between the fourth mounting surface and the fifth mounting surface and totally covers the second non-imaging portion in the projection plane.

4. The lens module of claim 3, wherein an outer diameter of the second light-shielding plate corresponds to that of the second lens.

5. The lens module of claim 3, wherein the lens module further comprises a spacer; the third non-imaging surface further comprises a six mounting surface opposite to the fifth mounting surface, the spacer is made of the black rubber and attached to the sixth mounting surface.

6. The lens module of claim 3, wherein the third lens is made of plastic and is an aspherical lens of negative refractive power.

7. The lens module of claim 3, wherein the second non-imaging portion further comprises a connection surface connecting the fourth mounting surface and the third imaging portion, the connection surface is conical and forms an acute angle related to the fourth mounting surface.

8. The lens module of claim 7, wherein the acute angle is greater than 15 degrees and less than 45 degrees.

9. The lens module of claim 1, wherein the first lens is made of plastic and is an aspherical lens of positive refractive power.

10. The lens module of claim 1, wherein the second lens is made of glass and is an aspherical lens of negative refractive power.

11. A lens module comprising:
a lens barrel;
a first lens received in the lens barrel, the first lens comprising:
a first imaging portion; and
a first non-imaging portion surrounding the first imaging portion; the first non-imaging portion comprising a first mounting surface perpendicular to an optical axis of the lens module and a second mounting surface opposite to the first mounting surface;
a second lens received in the lens barrel and comprising:
a second imaging portion; and
a second non-imaging portion surrounding the second imaging portion;
the second non-imaging portion comprising a third mounting surface perpendicular to the optical axis of the lens module; and
an annular first light-shielding plate received in the lens barrel for blocking light rays from the first non-image portion, the first light-shielding plate being mounted between the second mounting surface and the third mounting surface and totally covering the first non-imaging portion in a projection plane perpendicular to the optical axis.

12. The lens module of claim 11, wherein an outer diameter of the first lens corresponds to an inner diameter of the lens barrel, and an outer diameter of the first light-shielding plate corresponds to that of the first lens.

13. The lens module of claim 11, wherein the lens module further comprises a second light-shielding plate and a third lens; the second non-imaging portion further comprises a fourth mounting surface opposite to the third mounting surface; the third lens comprises a third imaging portion and a third non-imaging portion surrounding the third imaging portion; the third non-imaging portion comprises a fifth mounting surface perpendicular to the optical axis; the second light-shielding plate is mounted between the fourth mounting surface and the fifth mounting surface and totally covers the second non-imaging portion in the projection plane.

14. The lens module of claim 13, wherein an outer diameter of the second light-shielding plate corresponds to that of the second lens.
